(19) United States
(12) Patent Application Publication
(10) Pub. No.: US 2023/0129104 A1
(43) Pub. Date: Apr. 27, 2023

(54) VISIBLE LED-BASED FLEX WAVEGUIDE INTERCONNECTS

(71) Applicants: Bardia Pezeshki, Mountain View, CA (US); Robert Kalman, Mountain View, CA (US); Alexander Tselikov, Mountain View, CA (US); Drew Hallman-Osinski, Mountain View, CA (US)

(72) Inventors: Bardia Pezeshki, Mountain View, CA (US); Robert Kalman, Mountain View, CA (US); Alexander Tselikov, Mountain View, CA (US); Drew Hallman-Osinski, Mountain View, CA (US)

(21) Appl. No.: 18/049,657

(22) Filed: Oct. 26, 2022

Related U.S. Application Data
(60) Provisional application No. 63/272,106, filed on Oct. 26, 2021.

(51) Int. Cl. G02B 6/43; G02B 6/42

(52) U.S. Cl. CPC G02B 6/43; G02B 6/4246

(57) ABSTRACT

A parallel optical interconnect using a flexible waveguide array to transmit optical signals between transceivers is disclosed. The flexible waveguide array may have a plurality of waveguide cores formed between cladding attached to a flexible substrate. The ends of the flexible waveguide array may be connected to connector housings having the transmitters and receivers of the transceivers. The structure of the flexible waveguide array may be configured to be bendable and to also transmit both optical and electrical signals.

### CROSS-REFERENCE TO RELATED APPLICATIONS

This application claims the benefit of U.S. Provisional Patent Application No. 63/272,106, filed on Oct. 26, 2021, the disclosure of which is incorporated by reference herein.

### FIELD OF INVENTION

The present invention is related generally to optical interconnects using microLEDs, and more particularly to optical interconnects with a flexible waveguide.

### BACKGROUND OF THE INVENTION

Computing and networking performance requirements are seemingly ever-increasing. Prominent applications driving these requirements include data center servers, high-performance computing clusters, artificial neural networks, and network switches.

For decades, dramatic integrated circuit (IC) performance and cost improvements were driven by shrinking transistor dimensions combined with increasing die sizes, summarized in the famous Moore's Law. Transistor counts in the billions have allowed consolidation onto a single system-on-a-chip (SoC) of functionality that was previously fragmented across multiple ICs. However, Moore's Law appears to be reaching its limits as shrinking feature sizes below 10 nm results in decreasing marginal performance benefits with decreased yields and increased per-transistor costs.

Beyond these limitations, a single IC can only contain so much functionality, and that functionality is constrained because the IC's process cannot be simultaneously optimized for different functionality, e.g., logic, DRAM, and I/O. Increasingly, improving system performance is dependent on implementing very high bandwidth interconnects between multiple ICs.

Unfortunately, compared to the on-chip connections, today's chip-to-chip connections are typically much less dense and require far more power (for example normalized as energy per bit). These inter-IC connections are currently significantly limiting system performance. Specifically, the power, density, latency, and distance limitations of interconnects are far from what is desired.

New interconnect technologies that provide significant improvements in multiple performance aspects are highly desirable. It is well-known that optical interconnects may have fundamental advantages over electrical interconnects, even for relatively short interconnects of <<1 meter. Unfortunately, implementation of optical interconnects for inter-IC connections may face a host of problems. Included in these problems is that of coupling light from one IC to another IC. Electrical interconnect technology for inter-IC communications at a substrate or circuit board level may be relatively well-developed. The same may not be as true for optical interconnect technology for inter-IC communications, particularly for high-throughput applications that preferably do not negatively impact existing modes of electrical interconnections.

### BRIEF SUMMARY OF THE INVENTION

Aspect of some embodiments may utilize a high-speed array of LEDs coupled to an array of waveguides, where the waveguides may be formed on a shaped or flexible substrate in a largely one-dimensional array, where the LEDs may operate at speeds greater than 1 Gb/s. In some embodiments, the waveguides may have layers that are thin to allow tight bending of the assembly. In some embodiments, the waveguides may be bent from the horizontal to the vertical to allow coupling to an array of emitters or detectors that may be mounted face-up on the circuit board. In some embodiments, the waveguide assembly may have a non-rectangular shape, which allows the connection at the two ends to be arbitrarily positioned. In some embodiments, the flexible substrate may comprise metallic and dielectric layers, where some of the metallic layers may be patterned to create electrical transmission lines with well-defined impedance characteristics. In some embodiments, the optical waveguides layers may comprise dielectric layers in a stack of metallic and dielectric layers, where some of the metallic layers may be patterned to create electrical transmission lines with well-defined impedance characteristics. Some embodiments provide a parallel optical interconnect, comprising: a first optical transceiver including a plurality of first microLEDs and a plurality of first photodetectors, the first photodetectors monolithically integrated on a first silicon integrated circuit and the first microLEDs on the first silicon integrated circuit; a second optical transceiver including a plurality of second microLEDs and a plurality of second photodetectors, the second photodetectors monolithically integrated on a second silicon integrated circuit and the second microLEDs on the second silicon integrated circuit; a flexible substrate; and a plurality of waveguides on the flexible substrate, the waveguides being part of an optical link between the first optical transceiver and the second optical transceiver.

In some embodiments the waveguides comprise waveguide cores on cladding on the flexible substrate. In some embodiments the waveguides form a one-dimensional array of waveguides. In some embodiments the waveguides form two or more layers of waveguides. In some embodiments the waveguides have a numerical aperture between 0.2 and 0.7. In some embodiments the waveguides are multimode waveguides for wavelengths between 400 nm to 500 nm. In some embodiments the flexible substrate is comprised of a laminate of dielectric and metallic layers. In some embodiments at least some of the metallic layers are patterned to form electrical transmission lines. In some embodiments at least two of the layers of waveguides are separated by a metal layer. In some embodiments the metal layer is patterned to form electrical transmission lines. In some embodiments the first silicon integrated circuit includes first drivers for the first microLEDs and first electrical receiver circuitry for the first photodetectors, and the second silicon integrated circuit includes second drivers for the second microLEDs and second electrical receiver circuitry for the second photodetectors. In some embodiments a first end of the waveguides is in a first connector housing, the first connector housing including a first alignment feature, and wherein a second end of the waveguides is in a second connector housing, the second connector housing including a second alignment feature. In some embodiments the first alignment feature comprises a first connector alignment hole and the second alignment feature comprises a second connector alignment hole. In some embodiments the first connector housing is on a first standoff on the first silicon integrated circuit and the second connector housing is on a second standoff on the second silicon integrated circuit. In some embodiments the first standoff includes a first standoff alignment hole and the second standoff includes a second standoff alignment hole, with a first alignment pin in the first connector alignment hole and the first standoff alignment hole, and with a second alignment pin in the second connector alignment hole and the second standoff alignment hole.

These and other aspects of the invention are more fully comprehended upon review of this disclosure.

### BRIEF DESCRIPTION OF THE FIGURES

FIG. 1 is a diagram of a parallel optical interconnect, in accordance with aspects of the invention.

FIGS. 2A-B are block diagrams of an optical receiver and an optical transmitter, in accordance with aspects of the invention.

FIG. 3A is a cross-sectional diagram of one embodiment of a linear waveguide array, in accordance with aspects of the invention.

FIG. 3B is a cross-sectional diagram of another embodiment of a linear waveguide array, in accordance with aspects of the invention.

FIG. 4 is a cross-sectional diagram of multiple optical waveguide layers on top of multiple electrical interconnect layers in a flexible substrate, in accordance with aspects of the invention.

FIG. 5 is a cross-sectional diagram of optical waveguide layers embedded in dielectric layers of a flexible substrate with electrical interconnect layers, in accordance with aspects of the invention.

FIG. 6 is a diagram of a linear array of polymer waveguides on a flexible substrate together with a semiconductor chip that has high speed microLEDs and/or photodetectors mounted or built-in to the chip, in accordance with aspects of the invention.

FIGS. 7A-B are top and bottom perspective view diagrams of a flexible substrate supporting optical and/or electrical connections having connectors at both ends, in accordance with aspects of the invention.

FIG. 8 is a cross-sectional diagram of a connector showing the flexible substrate and waveguides bent in the connector to form a low-profile package, in accordance with aspects of the invention.

FIG. 9 is a top view diagram of S-shaped optical flexible substrate with waveguides, in accordance with aspects of the invention.

### DETAILED DESCRIPTION

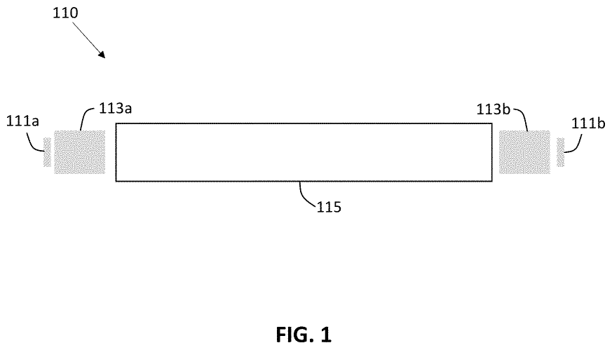

FIG. 1 shows a diagram of a parallel optical interconnect 110. In some embodiments, a parallel optical interconnect comprises a first optical transceiver array 111a, where the transceiver array comprises a plurality of optical transmitters and optical receivers, where each optical transmitter comprises a micro light emitting diode (microLED); a first coupling optics 113a, which may be in the form of a first optical coupling assembly that couples light between the first optical transceiver array and the first end of an optical transmission medium; an optical transmission medium 115; a second optical transceiver array 111b similar to the first optical transceiver array; and second coupling optics 113b, which may be a second optical coupling assembly similar to the first optical coupling assembly, which couples light between the second optical transceiver array and a second end of the optical transmission medium. The parallel optical interconnect may comprise multiple “lanes,” where each lane comprises one transmitter in one transceiver array whose output light is relayed via coupling optics and the optical transmission medium to a receiver in the other transceiver array. In some embodiments, a parallel optical interconnect comprises 8 to 1024 lanes. In some embodiments, each parallel optical interconnect lane has a throughput in the range of 1 Gbps to 10 Gbps.

Some embodiments use LED with structures that can be modulated at high speeds due to their short carrier lifetime. In some embodiments, these LEDs are used in optical interconnects where the communication interconnect may comprise one or a plurality of optical communication links in the form of a parallel optical interconnect. In some embodiments, the very low power and high density of LED-based parallel optical interconnects are used in mobile platforms such as mobile phones, tablets, and laptop computers. In some embodiments, the LED-based parallel optical interconnects have very low power and high density, which may be preferable in those mobile platforms, where both power and space may be at a premium.

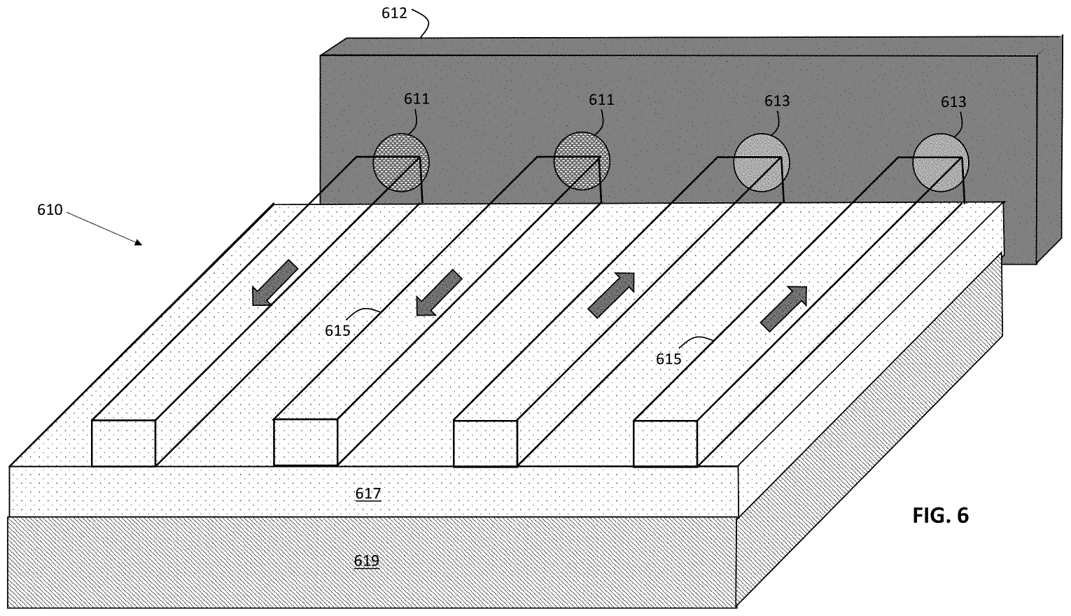

In some embodiments, for example as illustrated in FIG. 6, a transceiver array may include a plurality of microLEDs 611 and a plurality of detectors 613 on a substrate. The detectors may be photodetectors, for example high speed photodetectors. The microLEDs and the photodetectors may each be optically coupled to a corresponding waveguide core 615. The waveguide cores may be on cladding 617 (and in many embodiments may be axially surrounded by cladding). The cladding may be on a flexible substrate 619. In some embodiments, the use of the flexible substrate with other features allows for provision of a flexible optical transmission medium.

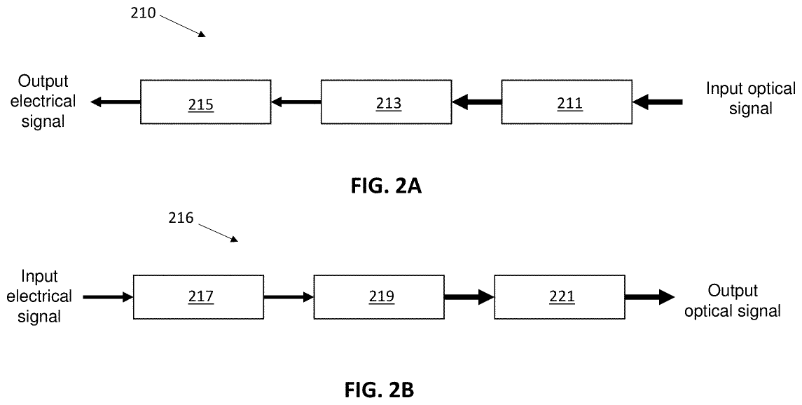

FIG. 2A shows a block diagram of an optical receiver 210. In some embodiments, each receiver in an optical transceiver array comprises collector optics 211, a photodetector 213, and a receiver circuit 215, with the collector optics and photodetector receiving an input optical signal and relaying such signal to the receiver circuit to produce an output electrical signal.

FIG. 2B shows a block diagram of an optical transmitter 216. In some embodiments, each transmitter in an optical transceiver array comprises a transmitter circuit 217, for example a drive circuit, a microLED 219, and an optical collector 221, where the output optical power of the microLED may be modulated by the drive circuit based on an electrical input signal to the drive circuit. In some embodiments a microLED is made from a p-n junction of a direct-bandgap semiconductor material. In some embodiments, a microLED is made from GaN. In some embodiments, a microLED is made from GaAs. In some embodiments, a microLED is made from InP.

In some embodiments, a microLED is distinguished from a semiconductor laser (SL) as follows: (1) a microLED does not have an optical resonator structure; (2) the optical output from a microLED is almost completely spontaneous emission, whereas the output from a SL is dominantly stimulated emission; (3) the optical output from a microLED is temporally and spatially incoherent, whereas the output from a SL has significant temporal and spatial coherence; (4) a microLED is designed to be driven down to a zero minimum current, whereas a SL is designed to be driven down to a minimum threshold current, which is typically at least 1 mA.

In some embodiments, a microLED is distinguished from a standard LED by (1) having an emitting region of less than 10 μm×10 μm; (2) frequently having cathode and anode contacts on top and bottom surfaces, whereas a standard LED typically has both positive and negative contacts on a single surface; (3) typically being used in large arrays for display and interconnect applications.

In some embodiments, each microLED used in a parallel optical interconnect is driven with a current in the range of 10 uA to 500 uA. In some embodiments, the per-bit energy consumed by each lane of a parallel optical interconnect is in the range of 0.05 pJ/bit to 1 pJ/bit.

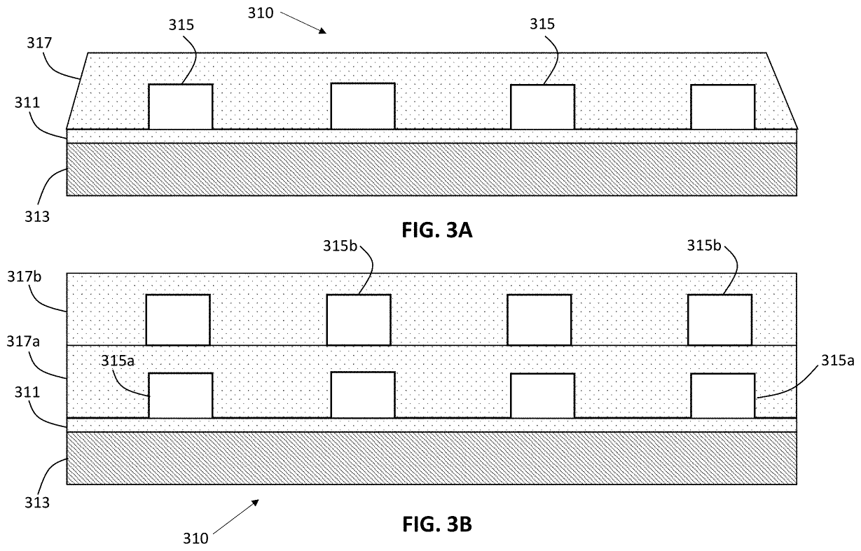

FIG. 3A shows a cross-sectional diagram of one embodiment of a linear waveguide array 310. In some embodiments, the transmission medium of a parallel optical interconnect comprises a one-dimensional (1D) array of waveguides on a flexible substrate. In some embodiments a bottom cladding layer 311 is on a flexible substrate 313, with waveguide cores 315 on the bottom cladding. Axially, sides, and tops of the cores may be surrounded by top cladding 317. Such parallel interconnects on flexible substrates are very useful in mobile platforms where components may be densely packed and flexible interconnects may be preferred to allow freedom in component placement.

FIG. 3B shows a cross-sectional diagram of another embodiment of a linear waveguide array 310. In some embodiments, the waveguide array may comprise two or more layers of waveguides, where each layer comprises a 1D waveguide array. In such a case, the top cladding of a given layer may act as the bottom cladding for the waveguide array in the next higher layer. As a result, there may exist two or more top cladding layers 317a-b surrounding the waveguide cores 315a-b. The number of top cladding layers may vary based on the number of layers of the waveguide array. In some embodiments, the first top cladding layer 317a along with the bottom cladding layer 311 may form around the first waveguide cores 315a of the first layer of the waveguide array. The bottom cladding may cover the bottom sides of the first waveguide cores and the top cladding layer may cover the left, right, and top sides of the first waveguide cores. The second layer of waveguide array may be formed on top of the first layer, with the second waveguide cores 315b attached on a top surface of the first top cladding layer and a second top cladding layer 317b forming around the second waveguide cores. As a result, the first top cladding layer may cover the bottom sides of the second waveguide cores and the second top cladding layer may cover the left, right, and top sides of the second waveguide cores. Such formation may be repeated for additional layers of the waveguide array. In some embodiments, the flexible substrate may be attached to the first layer of the waveguide array, particularly a surface of the bottom cladding that is opposite to the waveguide cores.

In some embodiments, the waveguides are made from polymer. In some embodiments, each waveguide comprises a core surrounded by a top cladding and bottom cladding, where the cladding has a lower index of refraction than the core. In some embodiments, each waveguide core has an approximately rectangular cross-section. In some embodiments, there may be multiple layers of waveguides.

As shown in FIGS. 3A-B, a thin lower index cladding may be fabricated onto a flexible substrate. The waveguides are then formed on top of this layer and patterned. A second lower index layer is fabricated over of the waveguide cores.

For relatively short reach interconnects (<1 meter) used in a typical mobile platform, a high numerical aperture is desired with a relatively large index difference between the core and the cladding. This allows the waveguides to capture more of the light from the LEDs. In some embodiments, the waveguides have an numerical aperture (NA) in the range of 0.2 to 0.7.

In some embodiments, the waveguide core material is comprised of a higher index polymer or epoxy such as SU8, while the lower and upper waveguide is comprised of a lower index polymer or epoxy such as PMMA. There are other materials that may be appropriate. In some embodiments of polymer waveguides, fluorination or other materials are used to tailor the refractive indices of the cladding and/or core layers.

The waveguides may be multimode at the wavelength of operation, which in some embodiments is in the range of 400 nm-500 nm. In some embodiments, the waveguide core transverse dimensions are in the range of 10 um to 50 um. In some embodiments, the waveguide transverse dimensions are in the range of 50 um to 100 um. In some embodiments, the spacing between waveguide cores is in the range of 3 um to 50 um. For instance, an array of 50 waveguides, each with a 40 um core width and spaced 10 um apart would be 2.5 mm wide. If each waveguide carries 4 Gb/s, the 50-lane parallel optical interconnect would carry 200 Gb/s of data—all typical numbers useful in computing applications.

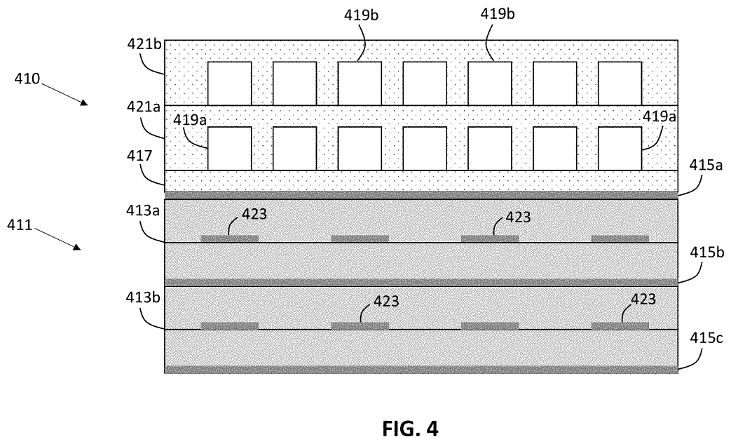

FIG. 4 shows a cross-sectional diagram of multiple optical waveguide layers on top of multiple electrical interconnect layers in a flexible substrate. In some embodiments, the flexible substrate on which the waveguides are formed comprises an electrical “flex circuit” 411, comprising a laminate of dielectric layers 413a-b and metallic layers 415a-c. In some embodiments, the flex circuit may be attached to the waveguide array 410, specifically to a surface of the bottom cladding 417 that is opposite to the surface that the first waveguide cores 419a are attached. In some embodiments, the waveguide array may comprise two or more layers of waveguides that may be similarly formed as described with respect to FIG. 3B. The first layer of the waveguide array may have first waveguide cores 419a surrounded by the bottom cladding and the first top cladding layer 421a. The second layer of the waveguide array may be on top of the first layer and have second waveguide cores 419b surrounded by the first and second top cladding layers 421a-b. This formation may repeat for additional layers of waveguide arrays.

The flex circuit may have two or more metallic layers 415a-c that are continuous along a length of the cross-section of the flex circuit and may have the dielectric layers 413a-b therebetween. In some embodiments, an inner metallic layer 415a may be attached to the bottom cladding of the waveguide array. A first dielectric layer 413a may be between and fill the space between the inner metallic layer and an intermediate metallic layer 415b. In some embodiments, a second dielectric layer 413b may exist between the intermediate metallic layer and an outer metallic layer 415c. In some embodiments, the metallic layers, or some of them, may have metallic patterns 423 within the dielectric layers and in between the continuous metallic layers to form high-speed electrical transmission line structures with well-defined impedance, such as striplines, microstrips, and coplanar waveguides. The metallic layers and patterns may also comprise various power and ground plane structures.

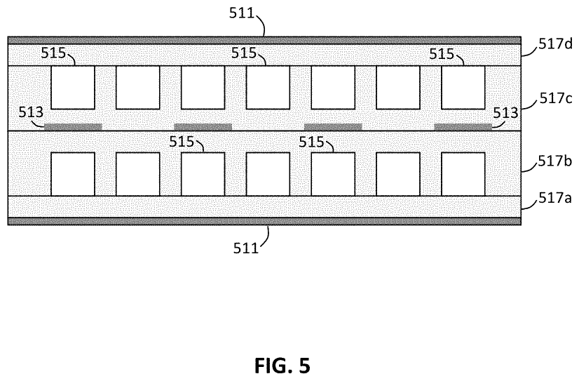

FIG. 5 shows a cross-sectional diagram of optical waveguide layers embedded in dielectric layers of a flexible substrate with electrical interconnect layers. In some embodiments, the optical waveguides may be embedded in laminated structures comprising metallic layers 511, metallic patterns 513, and dielectric layers. The waveguide cores 515 and cladding layers 517a-d of the waveguide array may be between the metallic layers that extend along a cross-sectional length and surround the outer surface of the waveguide array. In some embodiments, the layers of the waveguide array may be formed similar to what has been described in FIGS. 3-4. In some embodiments, there may exist a top planar cladding 517d and bottom planar cladding 517a that act as interfaces between the layers of the waveguide array and the outer metallic layers 511.

In some embodiments, the metallic layers, or some of them, may have metallic patterns 513, or otherwise electrical transmission line structures, and such metallic patterns may be embedded between the layers of the waveguide array and in between the waveguide cores 515. In some embodiments, the optical waveguide regions, including the waveguide cores 515 and/or the cladding layers 517a-d, may also serve as dielectric regions that are part of electrical interconnect structures such as striplines, microstrips, and coplanar waveguides. The benefits of this structure are (1) higher area density of interconnects; (2) fewer layers needed to be fabricated to support a given optical and electrical connectivity.

FIG. 6 shows a diagram of a linear array of polymer waveguides 610 on a flexible substrate 619 together with a semiconductor chip 612 that has high speed microLEDs 611 and/or photodetectors 613 mounted or built-in to the chip.

In some embodiments of a parallel optical interconnect, optical waveguides on a flexible substrate are optically coupled to an array of optoelectronic components comprising a plurality of microLEDs and/or photodetectors. In some embodiments, the waveguide cores 615 of the optical waveguides may be formed on and in-between claddings 617. In some embodiments, the photodetectors are monolithically integrated on a silicon integrated circuit with electrical receiver circuitry, possibly comprising transimpedance amplifiers, other receiver circuitry, and/or digital logic circuitry. In some embodiments, the microLEDs are fabricated on another substrate and then transferred onto a silicon integrated circuit (IC). In some embodiments, the silicon IC comprises transmitter circuitry such as drivers for the LEDs and/or other analog and digital circuitry. In some embodiments, the same integrated circuit comprises both transmitter and receiver circuitry.

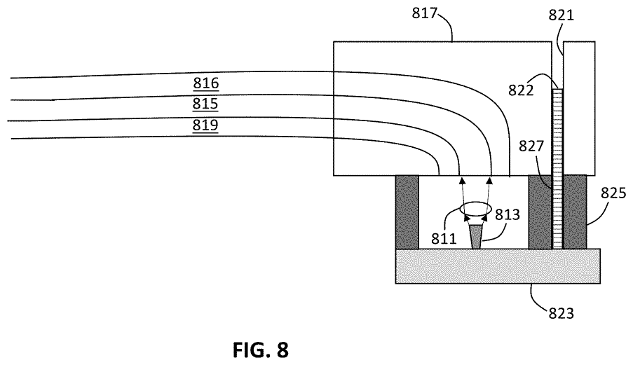

Some embodiments include components to increase or possibly maximize the efficiency in coupling light from each microLED to its respective waveguide. In some embodiments, and as shown in FIG. 8, a microlens 811 is interposed between each microLEDs 813 and its waveguide 815 to maximize collection of the microLED's emitted light into the waveguide. A microLED of a few microns in diameter that emits light in a Lambertian distribution could have its light collected into a smaller angular cone with the use of a microlens, at the penalty of increasing the beam size to a few tens of microns. If the waveguide width and numerical aperture are greater than the expanded optical beam width and angular distribution out of the microlens, high coupling efficiency from a microLED to a waveguide can be achieved.

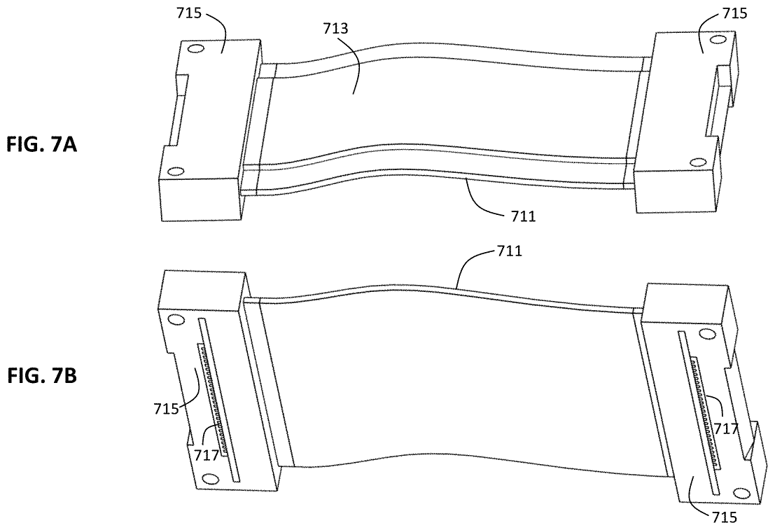

FIGS. 7A-B show top and bottom perspective view diagrams of a flexible substrate 711 supporting optical and/or electrical connections 713 having connectors 715 at both ends. From the bottom perspective view, particularly, the individual waveguides 717 making up the waveguide array may be seen. Given that the flexible substrate and the waveguide layers can be very thin, there is little mechanical stiffness and the resulting optical transmission medium supports a small bend radius. If the numerical aperture of the optical waveguides is large, the waveguides will have low optical loss even at small bend radii. This small bend radius is compatible with some embodiments using a low profile connector in which the substrate/waveguides turn 90°. This is shown in FIG. 7 as a complete flexible optical transmission medium with connectors on both ends.

FIG. 8 is a cross-sectional diagram of a connector 817 showing the flexible substrate 819 and waveguides 815 bent in the connector to form a low-profile package. The cladding 816 surrounding the waveguide cores may also be bent in the connector. In some embodiments, microLEDs 813 and photodetectors are vertically coupled into the waveguides, which turn include a 90° transiting in the connector housing 817, so the flexible substrate between connectors is oriented approximately horizontally. In other words, the flexible substrate along with the waveguide array bend from a horizontal orientation to a vertical position within the connector housing to couple with the microLEDs and photodetectors mounted vertically on the transceiver substrate 823. As a result, the connector housing acts as an interface to couple and bend the flexible substrate and waveguide array from a horizontal orientation to a vertical one towards the microLEDs and photodetector. In some embodiments, the connector supports both optical and electrical connections. In some embodiments, the flexible cable connected to the connector housing comprises both optical waveguides and electrical connections such as shown in FIG. 4 and FIG. 5. In some embodiments, the connector comprises alignment features such as alignment holes 821 that interface to an alignment pin 822 on a transceiver substrate 823 to which the microLEDs and photodetectors are mounted. In some embodiments, a standoff 825 may be used to allow placement of the connector housing on top of such structure at a predetermined height above the transceiver substrate with a microLED (or photodetector), and the standoff may include a cavity or hole 827 for an alignment pin with a corresponding cavity or hole in the cavity housing. The hole of the standoff may align with the hole of the connector for the pin to be inserted through both holes and secure the connector to the standoff. In some embodiments, the connector may also comprise optical and mechanical structures that maximize optical coupling efficiency such as microlenses and mechanical standoffs.

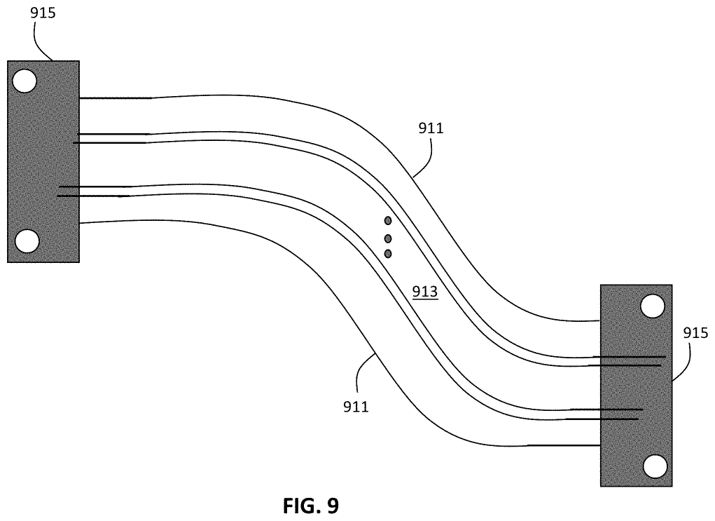

FIG. 9 shows a top view diagram of S-shaped optical flexible substrate 911 with waveguides 913. The type of a connector described herein could allow such optical flex assemblies to follow the vertical profile of a circuit board, and be useful for tight applications such as thin laptop computers or mobile phones. In the orthogonal “horizontal” direction, the flexible substrate could be formed to compose different shapes to work around constrictions. As shown in FIG. 9, a flexible substrate having the optical waveguide array in-between may have an S-shape that has connectors 915 with offsets. The ability to bend the flexible cable and form it in different shapes allows the use of optical links in environments where thicker cables would not be appropriate.

Some embodiments include features that may further enhance the usefulness of the use of the flexible optical transmission medium. For example, in some embodiments, there is one or more layer of waveguides on each of the two surfaces of the flexible substrate. In some embodiments, there is a mirror formed in the connector or in each waveguide that causes the light to turn 90° without requiring a tight bend. In some embodiments, there may be no bend in the waveguides, with the emitters and detectors mounted vertically on the board, for example as shown in FIG. 6. In some embodiments, the parallel optical interconnect is unidirectional with an array of optical transmitters (with microLEDs) comprising the transceiver array at one end of the parallel optical interconnect and an array of optical receivers (with photodetectors) comprising the transceiver array at the other end of the parallel optical interconnect.

In some embodiments of a parallel optical interconnect, each waveguide supports a bidirectional link, where there is a both a microLED and photodetector at each end of each waveguide. In some further embodiments, a microLED is mounted on top of a larger photodetector. In some further embodiments, the parallel optical interconnect is used in “half-duplex” mode such that either the microLED or the detector at each end of each waveguide can be electrically activated to set the direction of transmission. Mechanically, there are a host of methods of aligning the connectors to the optical device with various latching mechanisms.

Although the invention has been discussed with respect to various embodiments, it should be recognized that the invention comprises the novel and non-obvious claims supported by this disclosure.

What is claimed is:

1. A parallel optical interconnect, comprising:
a first optical transceiver including a plurality of first microLEDs and a plurality of first photodetectors, the first photodetectors monolithically integrated on a first silicon integrated circuit and the first microLEDs on the first silicon integrated circuit;
a second optical transceiver including a plurality of second microLEDs and a plurality of second photodetectors, the second photodetectors monolithically integrated on a second silicon integrated circuit and the second microLEDs on the second silicon integrated circuit;
a flexible substrate; and
a plurality of waveguides on the flexible substrate, the waveguides being part of an optical link between the first optical transceiver and the second optical transceiver.

2. The parallel optical interconnect of claim 1, wherein the waveguides comprise waveguide cores on cladding on the flexible substrate.

3. The parallel optical interconnect of claim 1, wherein the waveguides form a one-dimensional array of waveguides.

4. The parallel optical interconnect of claim 1, wherein the waveguides form two or more layers of waveguides.

5. The parallel optical interconnect of claim 1, wherein the waveguides have a numerical aperture between 0.2 and 0.7.

6. The parallel optical interconnect of claim 1, wherein the waveguides are multimode waveguides for wavelengths between 400 nm to 500 nm.

7. The parallel optical interconnect of claim 1, wherein the flexible substrate is comprised of a laminate of dielectric and metallic layers.

8. The parallel optical interconnect of claim 7, wherein at least some of the metallic layers are patterned to form electrical transmission lines.

9. The parallel optical interconnect of claim 4, wherein at least two of the layers of waveguides are separated by a metal layer.

10. The parallel optical interconnect of claim 9, wherein the metal layer is patterned to form electrical transmission lines.

11. The parallel optical interconnect of claim 1, wherein the first silicon integrated circuit includes first drivers for the first microLEDs and first electrical receiver circuitry for the first photodetectors, and the second silicon integrated circuit includes second drivers for the second microLEDs and second electrical receiver circuitry for the second photodetectors.

12. The parallel optical interconnect of claim 1, wherein a first end of the waveguides is in a first connector housing, the first connector housing including a first alignment feature, and wherein a second end of the waveguides is in a second connector housing, the second connector housing including a second alignment feature.

13. The parallel optical interconnect of claim 12, wherein the first alignment feature comprises a first connector alignment hole and the second alignment feature comprises a second connector alignment hole.

14. The parallel optical interconnect of claim 13, wherein the first connector housing is on a first standoff on the first silicon integrated circuit and the second connector housing is on a second standoff on the second silicon integrated circuit.

15. The parallel optical interconnect of claim 14 wherein the first standoff includes a first standoff alignment hole and the second standoff includes a second standoff alignment hole, with a first alignment pin in the first connector alignment hole and the first standoff alignment hole, and with a second alignment pin in the second connector alignment hole and the second standoff alignment hole.
